(19) United States
(12) Patent Application Publication
(10) Pub. No.: US 2025/0066880 A1
(43) Pub. Date: Feb. 27, 2025

(54) METHOD FOR MANUFACTURING HIGH-STRENGTH TITANIUM ALLOY BY USING FERROCHROME, AND HIGH-STRENGTH TITANIUM ALLOY

(71) Applicant: KOREA INSTITUTE OF MATERIALS SCIENCE, Changwon-si Gyeongsangnamdo (KR)

(72) Inventors: Jong-Taek YEOM, Gimhae-si Gyeongsangnam-do (KR); Chan-Hee PARK, Changwon-si Gyeongsangnam-do (KR); Jae-Keun HONG, Changwon-si, Gyeongsangnam-do (KR)

(21) Appl. No.: 18/725,512

(22) PCT Filed: Dec. 6, 2022
(86) PCT No.: PCT/KR2022/019725

§ 371 Date: Jun. 28, 2024

(30) Foreign Application Priority Data
Dec. 29, 2021 (KR) 10-2021-0191855

(51) Int. Cl. C22C 14/00; C22C 1/02; C22F 1/18

(52) U.S. Cl. CPC C22C 14/00; C22C 1/02; C22F 1/183

(57) ABSTRACT

A method for manufacturing a high-strength titanium alloy by using ferrochrome, and a high-strength titanium alloy are disclosed. The method for manufacturing a high-strength titanium alloy, according to the present invention, comprises the steps of adding ferrochrome, which comprises Cr, Fe, Si and C, to pure Ti, melting and cooling same so as to form a titanium alloy base material, and then hot forming the formed titanium alloy base material. The ferrochrome is added in an amount of less than 4 wt %.

### DESCRIPTION

### Field

The present disclosure relates to a method for preparing high-strength titanium. More specifically, the present disclosure relates to a method for preparing a high-strength titanium alloy using ferrochrome.

Additionally, the present disclosure relates to a titanium alloy that may exhibit high strength with good elongation.

### Description of Related Art

Titanium has excellent specific strength, corrosion resistance, and biocompatibility, and is widely used in a wide range of industries, including aerospace, national defense, energy industry, medical care, and consumer staples.

In general, titanium alloys are classified into pure titanium, an alpha (a) alloy, an alpha-beta (a-B) alloy, and a beta (B) alloy based on a stable phase at a room temperature. Among those, the alpha alloy is known to have excellent creep strength, weldability, and the like, while the beta alloy is known to increase machinability.

Pure titanium is cheaper than other titanium alloys in terms of price, and has excellent formability, weldability, processability, and corrosion resistance. However, pure titanium has low strength and thus has limitations in applications. Most of the fields of application of titanium require high-strength characteristics, and in this case, adding a large amount of alloy elements raises a risk of becoming expensive.

Therefore, there is a need for a development of a titanium alloy composed of relatively inexpensive elements that may control properties such as excellent strength, formability, weldability, processability, corrosion resistance, and biocompatibility while minimizing the price increase, and a method for preparing the same.

### DISCLOSURE

### Technical Purposes

The present disclosure is to provide a method for preparing a high-strength titanium alloy using ferrochrome. In particular, the present disclosure is to provide a method for preparing a high-strength titanium alloy that not only lowers a preparation cost of the titanium alloy using ferrochrome as an alloy additive, but is also advantageous in terms of securing strength and elongation.

Additionally, the present disclosure is to provide a titanium alloy with high strength along with a good elongation.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

### Technical Solutions

A method for preparing a high-strength titanium alloy according to an embodiment of the present disclosure to solve the above problems includes (a) adding ferrochrome including chromium (Cr), iron (Fe), silicon (Si), and carbon (C) to pure titanium (Ti), (b) melting a result of the (a) and then cooling the result to form a titanium alloy base material, and (c) hot forming the titanium alloy base material, and the ferrochrome is added in an amount equal to or smaller than 4% by weight with respect to a total weight of the titanium alloy.

A method for preparing a high-strength titanium alloy according to a preferred embodiment of the present disclosure includes (a) adding ferrochrome including chromium (Cr), iron (Fe), silicon (Si), and carbon (C) to pure titanium (Ti), (b) melting a result of the (a) and then cooling the result to form a titanium alloy base material, and (c) hot forming the titanium alloy base material, the ferrochrome includes iron (Fe): 20 to 35% by weight, silicon (Si): 1 to 4% by weight, and carbon (C): equal to or smaller than 0.15% by weight, with a remainder composed of chromium (Cr) and inevitable impurities, and the ferrochrome is added in an amount equal to or smaller than 4% by weight with respect to a total weight of the titanium alloy. In this case, the prepared titanium alloy includes chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, with a remainder composed of titanium (Ti) and inevitable impurities, and has a tensile strength in a range of 861 to 1165 MPa.

The ferrochrome may be added in an amount in a range of 0.5 to 2% by weight with respect to the total weight of the titanium alloy.

The hot forming may be performed in a temperature range of 800 to 850° C. with a forming ratio equal to or lower than 90%.

The titanium alloy according to the embodiment of the present disclosure to solve the above problems may include chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, with a remainder composed of titanium (Ti) and inevitable impurities.

A high-strength titanium alloy according to a preferred embodiment of the present disclosure includes chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, wherein the content of chromium (Cr) is greater than the content of iron (Fe), wherein the high-strength titanium alloy also includes a remainder composed of titanium (Ti) and inevitable impurities, and the high-strength titanium alloy has a tensile strength in a range of 861 to 1165 MPa.

The content of chromium may be 1.7 to 4 times the content of iron.

The titanium alloy may have a molybdenum equivalent weight ([Mo]eq.), expressed in Equation 1 below, equal to or smaller than 5 and have a beta transformation point in a range of 840 to 930° C. ([ ] in Equation 1 is a % by weight of a corresponding component).

$$[ Mo ] eq . = [ Mo ] + 0.2 [ Ta ] + 0.28 [ Nb ] + 0.4 [ W ] + 0.67 [ V ] + 1 \text{.25} [ Cr ] + 1.25 [ Ni ] + 1.7 [ Mn ] + 1.7 [ Co ] + 2.5 [ Fe ] \qquad [ Equation l ]$$

The titanium alloy may have a yield strength in a range of 460 to 1280 MPa and a Young's modulus in a range of 95 to 105 GPa.

### Technical Effects

According to the method for preparing the high-strength titanium alloy according to the present disclosure, using low-carbon ferrochrome, which is composed of the elements (Cr, Fe, Si, and the like) harmless to the human body, as the additive alloy material to pure titanium (commercial pure titanium) may not only lower the cost in terms of a raw material price and a process, but also provide advantageous effects in terms of securing the strength and the elongation, compared to adding Cr, Fe, Si, and the like as individual elements.

In addition to the above-described effects, specific effects of the present disclosure will be described together while describing specific details for carrying out the disclosure below.

### BRIEF DESCRIPTION OF DRAWINGS

FIG. 1A shows a phase fraction of a pure titanium (Ti-0.05 O) specimen.

FIG. 1B shows a phase fraction of a specimen prepared by adding 4% by weight of ferrochrome to pure titanium (Ti-0.05 O).

FIG. 1C shows a phase fraction of a specimen prepared by adding 0.5% by weight of ferrochrome to pure titanium (Ti-0.05 O).

FIG. 2A shows a phase fraction of a pure titanium (Ti-0.39 O) specimen.

FIG. 2B shows a phase fraction of a specimen prepared by adding 4% by weight of ferrochrome to pure titanium (Ti-0.39 O).

FIG. 2C shows a phase fraction of a specimen prepared by adding 0.5% by weight of ferrochrome to pure titanium (Ti-0.39 O).

FIG. 3A shows mechanical properties of specimens according to Comparative Examples 1 and 3 and specimens according to Present Examples 1 to 4.

FIG. 3B shows mechanical properties of specimens according to Comparative Examples 2 and 4 and specimens according to Present Examples 5 to 8.

### DETAILED DESCRIPTIONS

The above-mentioned purposes, features, and advantages will be described in detail later, so that a person skilled in the art in the technical field to which the present disclosure belongs will be able to easily implement the technical ideas of the present disclosure. In describing the present disclosure, when it is determined that a detailed description of the publicly known technology related to the present disclosure may unnecessarily obscure the gist of the present disclosure, the detailed description will be omitted. Hereinafter, a preferred embodiment according to the present disclosure will be described in detail with reference to the attached drawings.

Hereinafter, a method for preparing a high-strength titanium alloy using ferrochrome, and the high-strength titanium alloy according to some embodiments of the present disclosure will be described.

As methods to increase a strength of pure titanium, there are a method to increase the strength by adding alloy elements, and a method to increase the strength by reducing a size of internal grains via plastic working and heat treatment. However, such methods cause an increase in price because the alloy elements are added and the separate grain size reduction process is added. In addition, in the case of the method of reducing the size of the grains via the plastic working and the heat treatment, mechanical properties of the titanium alloy prepared based on the process may change significantly, and thus a process that is difficult to be directly applied to an actual production process may be derived.

Therefore, the method of adding the alloy elements may be considered more advantageous than the method of reducing the size of the grains via the plastic working and the heat treatment. In particular, selecting inexpensive alloy elements and alloying them may be considered the most desirable method in minimizing the price increase and increase the strength. Furthermore, to ensure biostability, it is desirable not to add toxic elements such as Co, Cu, Ni, V, and the like. The titanium alloy according to the present disclosure does not include such elements. However, as an exception, such elements may be unavoidably included as impurities.

As a result of long-term research, the inventors of the present disclosure developed a method for alloying pure titanium by adding ferrochrome, which includes non-toxic and easily soluble elements such as Fe, Cr, and Si, thereto. In particular, Si, the element included in ferrochrome, may be expected to have additional feature of providing a nucleation site during melting and reducing a size of grains of the melted ingot. Accordingly, a new Ti—Cr—Fe—Si alloy based on pure titanium was developed.

Hereinafter, the method for preparing the high-strength titanium alloy using ferrochrome will be described in more detail.

The high-strength titanium alloy preparing method according to the present disclosure includes adding ferrochrome including chromium (Cr), iron (Fe), silicon (Si), and carbon (C) to pure titanium (Ti), forming a titanium alloy base material by melting and then cooling pure titanium and ferrochrome, and hot forming the titanium alloy base material.

For the melting of pure titanium and ferrochrome, various known methods such as a vacuum melting method, an electron beam melting method, a plasma arc melting method, a non-consumable electrode arc melting method, or an induction skull melting method may be used. The hot forming may be performed by methods such as hot rolling and hot forging. The hot forming may be performed in a temperature range of 800 to 850° C. with a forming ratio of 90% or lower. The forming ratio may be expressed as a reduction rate in the case of rolling. In the case of the present disclosure, as will be described below, ferrochrome is added in an amount smaller than 4% by weight. As a result, cracks may not occur even when the forming is performed in the temperature range of 800 to 850° C. with the forming ratio of 90%.

For the cooling after the hot forming, various methods such as water cooling, air cooling, and furnace cooling may be used. The cooling method may be determined depending on presence or absence of an additional hot process after the hot forming. For example, when the additional hot process does not exist, the water cooling may be performed after the hot forming. After the hot forming, an additional heat treatment such as homogenization treatment, solution heat treatment, and aging treatment may be performed.

One characteristic regarding the melting of ferrochrome is that a temperature when melting ferrochrome is significantly lower than a temperature when melting chromium, iron, silicon, and the like individually, and is similar to a melting point of titanium. Accordingly, ferrochrome may be melted with pure titanium at a relatively low temperature, thereby reducing a cost of preparing titanium alloy.

In the present disclosure, it is desirable that an amount of ferrochrome added is smaller than 4% by weight with respect to a total weight of titanium alloy. More preferably, the added amount may be equal to or smaller than 3% by weight, and most preferably, may be in a range of 0.5 to 2% by weight. The addition of ferrochrome may increase strength compared to that of pure titanium. However, when the amount of ferrochrome added is equal to or greater than 4% by weight, an elongation is very low and there is a risk of the occurrence of the cracks.

Ferrochrome may include iron (Fe): 20 to 35% by weight, silicon (Si): 1 to 4% by weight, and carbon (C): equal to or smaller than 0.15% by weight, with a remainder composed of chromium (Cr) and inevitable impurities. A characteristic of ferrochrome is that the Cr content is much greater than the Fe content. In ferrochrome, the Cr content may be 1.7 to 4 times, for example, 2 to 4 times, the Fe content.

Chromium (Cr), as a non-toxic element and is a beta phase stabilizing element more effective than molybdenum (Mo) in the titanium alloy. Adding chromium to pure titanium may increase the strength because of a solid solution strengthening effect. However, when excessive chromium is added, there is a high possibility of fracture during the forming process because of formation of a Laves phase (TiCr₂). For example, it is known that, in titanium alloys such as a Ti-33Zr-3Fe-2Cr alloy, a Ti-33Zr-5Fe-2Cr alloy, and a Ti-33Zr-7Fe-2Cr alloy, when Cr is added, the Laves phase is formed, and as a result, a cracking behavior is exhibited (during a compression test).

Iron (Fe), like chromium (Cr), is not toxic and is the beta phase stabilizing element more effective than molybdenum. Adding iron to pure titanium may increase the strength because of the solid solution strengthening effect. However, when melting a titanium alloy with 2% by weight or a greater amount of iron added, macro or micro segregation may be induced. Further, when the titanium alloy with 2% by weight or the greater amount of iron added is heat treated at a certain temperature, a TiFe phase, a fairly fragile phase, may be formed.

Silicon (Si), as a non-toxic element, forms many nucleation sites and induces the grain size reduction when melting the titanium alloy. Further, silicon contributes to increasing static strength of the titanium alloy. However, when the silicon content exceeds 0.25% by weight, the crack occurrence may be promoted because of formation of highly brittle silicide.

When the ferrochrome content is smaller than 4% by weight, the above desirable content ranges for chromium, iron, and silicon may be met in the titanium alloy.

The titanium alloy according to the present disclosure may include oxygen (O) in an amount equal to or smaller than 0.4% by weight with respect to the total weight of the titanium alloy. Oxygen, as an interstitial element, is a solid solution strengthening alloying element that strengthens a lattice without significantly affecting corrosion resistance. However, when oxygen is excessively included, exceeding 0.4% by weight, impact resistance may be drastically reduced by suppressing twin deformation at a low temperature.

With the above method, the present disclosure may provide the high-strength titanium alloy composed of chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, with the remainder composed of titanium (Ti) and inevitable impurities. In the high-strength titanium alloy according to the present disclosure, the Cr, Fe and Si contents may be determined based on the amount of ferrochrome added. The above Cr, Fe and Si contents may be met as the amount of ferrochrome added is smaller than 4% by weight, more preferably equal to or smaller than 3.0% by weight, and most preferably in a range of 0.5 to 2.0% by weight.

The high-strength titanium alloy according to the present disclosure may have a molybdenum equivalent weight ([Mo]eq.) equal to or smaller than 5, expressed in Equation 1 below ([ ] in Equation 1 is a % by weight of a corresponding component).

$$[ Mo ] eq . = [ Mo ] + 0.2 [ Ta ] + 0.28 [ Nb ] + 0.4 [ W ] + 0.67 [ V ] + 1 \text{.25} [ Cr ] + 1.25 [ Ni ] + 1.7 [ Mn ] + 1.7 [ Co ] + 2.5 [ Fe ] \qquad [ Equation l ]$$

Additionally, high-strength titanium alloy according to the present disclosure may have a beta transformation point in a range of 840 to 930° C.

Furthermore, as a result of the experiment, the high-strength titanium alloy according to the present disclosure may have a tensile strength in a range of 540 to 1370 MPa, and more preferably, in a range of 861 to 1165 MPa when also considering the elongation according to Present Examples below, a yield strength in a range of 460 to 1280 MPa and a Young's modulus in a range of 95 to 105 GPa.

### PRESENT EXAMPLES

Hereinafter, a composition and an operation of the present disclosure will be described in more detail with preferred present examples of the present disclosure. However, these are presented as desirable examples of the present disclosure and are not able to be interpreted as limiting the present disclosure in any way. Contents not described in the following present examples may be sufficiently inferred technically by anyone skilled in the art, so that description thereof will be omitted.

### 1. Ferrochrome Analysis

Compositions of three ferrochrome specimens were analyzed as follows. EDS analysis was performed three times respectively at three positions (left, center, and right) of each specimen of 10 mm×10 mm size, and results are shown in Table 1.

TABLE 1
(Unit: % by weight)

| | #1(%) | #2(%) | #3(%) | Average(%) |
|---|---|---|---|---|
| Si | 2.58 | 3.81 | 3.42 | 3.27 |
| Cr | 66.80 | 66.31 | 63.84 | 65.65 |
| Fe | 30.61 | 29.87 | 32.74 | 31.07 |

It may be seen that all the three specimens include about 66% by weight of Cr, about 31% by weight of Fe, and about 3% by weight of Si, and differences in the contents of the components are not great.

Hereinafter, an experiment was conducted on a ferrochrome specimen #1.

After removing a surface oxide layer of the ferrochrome specimen #1, results of analyzing contents of O, N, H, and C using the EDS are shown in Table 2.

TABLE 2

| | O | N | H | C |
|---|---|---|---|---|
| % by weight | 0.034 | 0.003 | 0.001 | 0.100 |

Depending on a carbon content, ferrochrome is classified into low-carbon ferrochrome, medium-carbon ferrochrome, and high-carbon ferrochrome. Among those, low-carbon ferrochrome means that the carbon content is equal to or smaller than 0.2% by weight or equal to or smaller than 0.15% by weight. The ferrochrome specimen #1 analyzed above corresponds to low-carbon ferrochrome as the carbon content is about 0.1% by weight and the chromium content is about 67%.

Melting points of Cr, Fe, and Si are 1907° C., 1538° C., and 1414° C., respectively, but a melting point of low-carbon ferrochrome with the carbon content equal to or smaller than 0.15% by weight is known to be about 1620° C. Additionally, a melting point of titanium is 1668° C.

In titanium, O, N, C, H, and the like are major elements that reduce ductility and require special management. In pure titanium, such elements should be managed to have contents equal to or smaller than percentages by weight shown in Table 3 (there are very small differences in allowable values by country). In particular, H reduces the ductility even when added in small amounts, so that special management is required compared to other elements.

TABLE 3

| Grade | O | N | C | Fe | H |
|---|---|---|---|---|---|
| Grade 1 | 0.18 max | 0.03 max | 0.10 max | 0.20 max | 0.015 max |
| Grade 2 | 0.25 max | 0.03 max | 0.10 max | 0.30 max | 0.015 max |
| Grade 3 | 0.35 max | 0.05 max | 0.10 max | 0.30 max | 0.015 max |
| Grade 4 | 0.40 max | 0.05 max | 0.10 max | 0.50 max | 0.015 max |

The ferrochrome specimen #1 analyzed above is a low-carbon ferrochrome and complies with maximum percentage by weight limits for the elements such as O, N, C, H, and the like in Table 3.

### Preparation of Titanium Alloy Specimens

Pure titanium (Ti-0.05 O and Ti-0.39 O) and ferrochrome with contents shown in Table 4 were melted in an induction skull melting furnace to form titanium alloys, and then the titanium alloys were cooled to produce ingots with width 10 mm×length 30 mm×thickness 10 mm.

The ingots were rolled at 830° C.±20° C. at a forming ratio of about 90% shown in Table 4 and then water-cooled to prepare titanium alloy specimens according to Comparative Examples 1 to 2 and Present Examples 1 to 8.

Table 4 shows a Mo equivalent weight and a beta transformation point based on the ferrochrome content in each of the titanium alloy specimens prepared according to Comparative Examples 1 to 2 and Present Examples 1 to 8. Further, Table 5 shows contents of Cr, Fe, and Si based on ferrochrome added in the titanium alloy specimens according to Present Examples 1 to 8.

TABLE 4

| | | | | | | Beta |
|---|---|---|---|---|---|---|
| | | Ferro- | O | Forming | Mo | transformation |
| | | chrome | (wt. | ratio | equivalent | point |
| | No. | (wt. %) | %) | (%) | weight | (° C.) |
| Com- | 1 | 0 | 0.05 | 87.15 | 0 | 891 |
| parative | 2 | 0 | 0.39 | 88.21 | 0 | 935 |
| Example | | | | | | |
| Present | 1 | 0.5 | 0.05 | 88.49 | 0.8 | 883 |
| Example | 2 | 1 | 0.05 | 90.04 | 1.6 | 874 |
| | 3 | 2 | 0.05 | 88.41 | 3.2 | 855 |
| | 4 | 3 | 0.05 | 88.43 | 4.8 | 840 |
| | 5 | 0.5 | 0.39 | 89.79 | 0.8 | 930 |
| | 6 | 1 | 0.39 | 87.53 | 1.6 | 922 |
| | 7 | 2 | 0.39 | 87.31 | 3.2 | 910 |
| | 8 | 3 | 0.39 | 87.52 | 4.8 | 900 |

TABLE 5

| | | Ferro- | | | | |
|---|---|---|---|---|---|---|
| | | chrome | Cr(wt. | Fe(wt. | Si (wt. | O(wt. |
| | No. | (wt. %) | %) | %) | %) | %) |
| Com- | 1 | 0 | 0 | 0 | 0 | 0.05 |
| parative | 2 | 0 | 0 | 0 | 0 | 0.39 |
| Example | | | | | | |
| Present | 1 | 0.5 | 0.33 | 0.155 | 0.015 | 0.05 |
| Example | 2 | 1 | 0.66 | 0.31 | 0.03 | 0.05 |
| | 3 | 2 | 1.32 | 0.62 | 0.06 | 0.05 |
| | 4 | 3 | 1.98 | 0.93 | 0.09 | 0.05 |
| | 5 | 0.5 | 0.33 | 0.155 | 0.015 | 0.39 |
| | 6 | 1 | 0.66 | 0.31 | 0.03 | 0.39 |
| | 7 | 2 | 1.32 | 0.62 | 0.06 | 0.39 |
| | 8 | 3 | 1.98 | 0.93 | 0.09 | 0.39 |

[symbol]

Cr:Fe:Si = 66:31:3

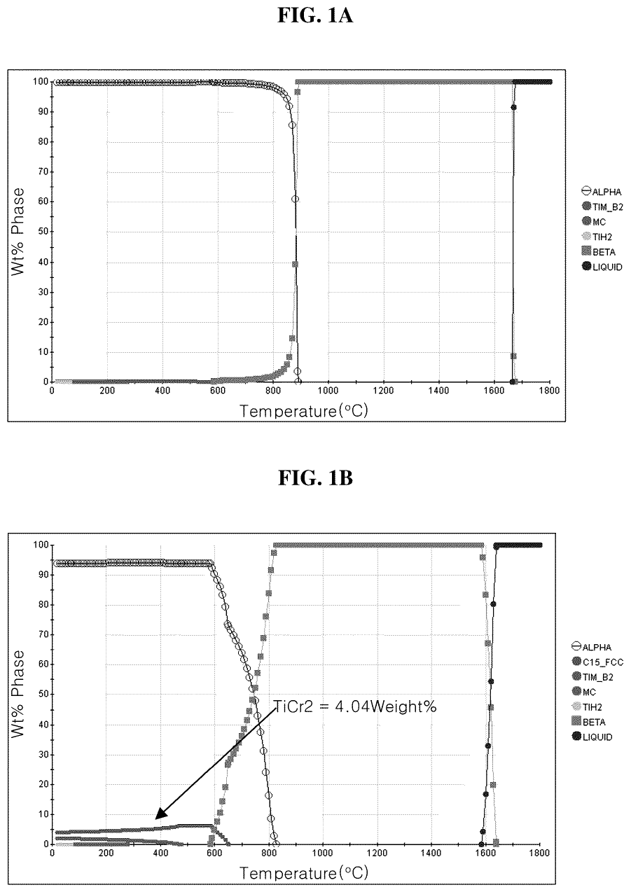

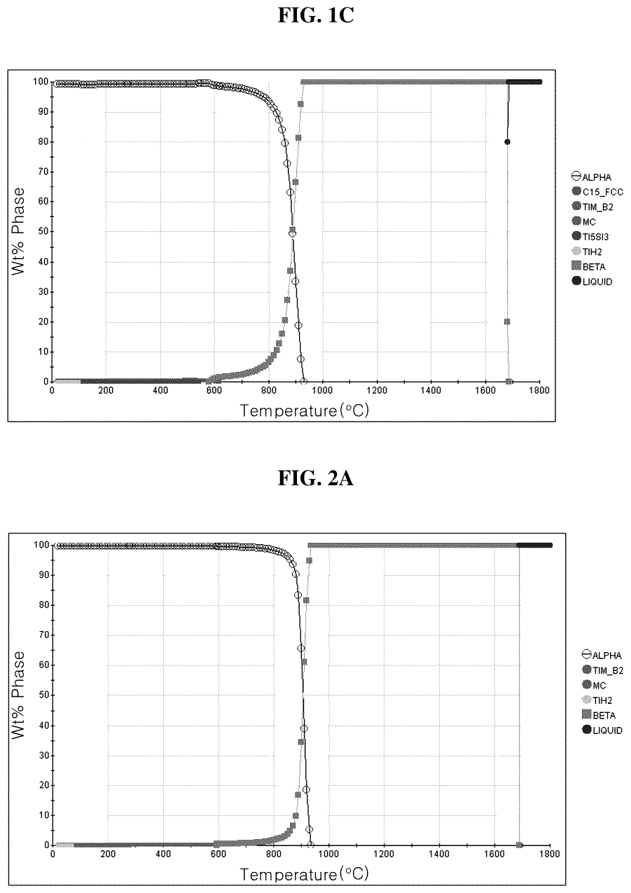

FIG. 1A shows a phase fraction of a specimen according to Comparative Example 1, which is a pure titanium (Ti-0.05 O) specimen. FIG. 1B shows a phase fraction of a titanium alloy specimen prepared by adding 4% by weight of ferrochrome to pure titanium (Ti-0.05 O). FIG. 1C shows a phase fraction of a titanium alloy specimen prepared by adding 0.5% by weight of ferrochrome to pure titanium (Ti-0.05 O).

Pure titanium (Ti-0.05 O) used in FIGS. 1A to 1C corresponds to Grade 1 or Grade 2 with an oxygen content of about 0.05% by weight.

Referring to Table 4 and FIG. 1A, it may be seen that pure titanium (Ti-0.05 O) exists in a beta phase at a high temperature equal to or higher than about 890° C., and substantially exists only in an alpha phase at a low temperatures equal to or lower than 890° C.

However, referring to Table 4 and FIG. 1B, it may be seen that the titanium alloy specimen prepared with 4% by weight of ferrochrome added exists in the beta phase at a high temperature equal to or higher than about 850° C., exists in a mixture of the beta phase and the alpha phase in a temperature range of 600 to 850° C., and exists in the alpha phase at a temperature equal to or lower than about 600° C. In particular, referring to FIG. 1B, it may be seen that TiCr₂ precipitated in a range of 600 to 650° C. during phase transformation from a high-temperature beta phase to a low-temperature alpha phase. When such TiCr₂ is excessive, there is a possibility of fracture during the forming process.

On the other hand, referring to FIG. 1C, the titanium alloy specimen prepared with 0.5% by weight of ferrochrome added may be considered more advantageous in the forming process because almost no precipitates are formed, unlike in FIG. 1B.

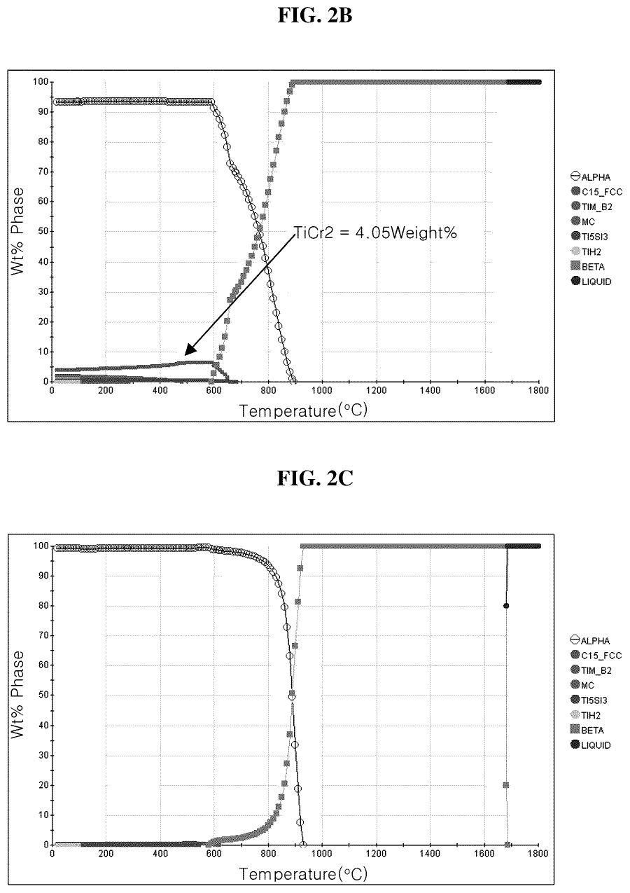

FIG. 2A shows a phase fraction of a specimen according to Comparative Example 2, which is a pure titanium (Ti-0.39 O) specimen. FIG. 2B shows a phase fraction of a titanium alloy specimen prepared by adding 4% by weight of ferrochrome to pure titanium (Ti-0.39 O). FIG. 2C shows a phase fraction of a titanium alloy specimen prepared by adding 0.5% by weight of ferrochrome to pure titanium (Ti-0.39 O).

Pure titanium (Ti-0.39 O) used in FIGS. 2A to 2C may be considered to correspond to Grade 4 with an oxygen content of about 0.39% by weight.

Referring to Table 4 and FIG. 2A, it may be seen that pure titanium (Ti-0.39 O) exists in the beta phase at a high temperature equal to or higher than about 930° C., and substantially exists only in the alpha phase at a low temperature equal to or lower than 930° C.

However, referring to Table 4 and FIG. 2B, it may be seen that the titanium alloy specimen prepared with 4% by weight of ferrochrome added exists only in the beta phase at a high temperature equal to or higher than about 910° C., exists in a mixture of the beta phase and the alpha phase in a temperature range of 600 to 910° C., and exists in the alpha phase at a temperature equal to or lower than 600° C. In particular, referring to FIG. 2B, it may be seen that TiCr₂ precipitated in a temperature range of about 600 to 650° C. during phase transformation from the high-temperature beta phase to the low-temperature alpha phase.

On the other hand, referring to FIG. 2C, it may be seen that almost no precipitates were formed in the titanium alloy specimen prepared with 0.5% by weight of ferrochrome added, unlike in FIG. 2B.

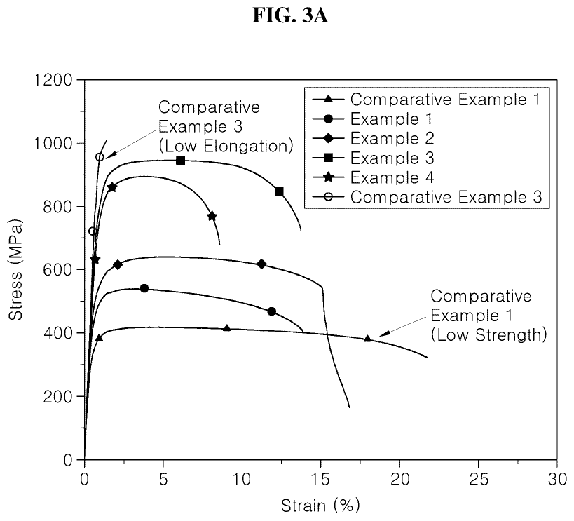

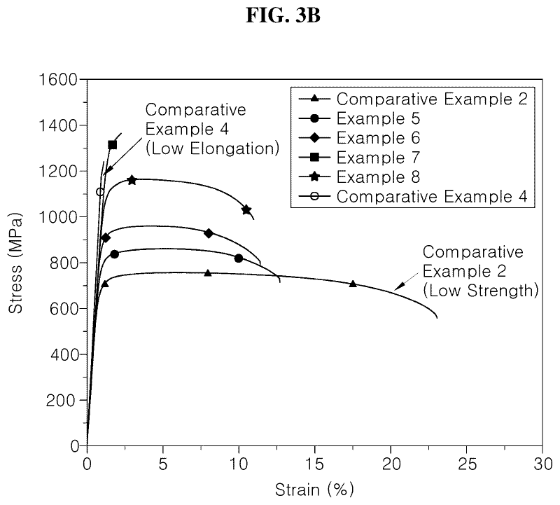

FIGS. 3A and 3B show mechanical properties of specimens according to Comparative Examples 1 to 4 and specimens according to Present Examples 1 to 8.

The specimen according to Comparative Example 3 is a titanium alloy specimen prepared by adding 4% by weight of ferrochrome to pure titanium (Ti-0.05 O), and the specimen according to Comparative Example 4 is a titanium alloy specimen prepared by adding 4% by weight of ferrochrome to pure titanium (Ti-0.39 O).

The mechanical properties were obtained by performing a tensile test on each titanium alloy specimen at the room temperature and a strain rate of 1.5 mm/min.

The mechanical properties for specimens according to Comparative Examples 1 to 2 and specimens according to Present Examples 1 to 8 are shown in Table 6.

TABLE 6

| | | Tensile | Yield | | Young's |
|---|---|---|---|---|---|
| | | strength | strength | Elongation | modulus |
| | No. | (MPa) | (MPa) | (%) | (MPa) |
| Comparative | 1 | 418 | 352 | 21.8 | 93 |
| Example | 2 | 758 | 672 | 23.1 | 103 |
| Present | 1 | 540 | 460 | 13.9 | 99 |
| Example | 2 | 640 | 514 | 16.8 | 98 |
| | 3 | 946 | 803 | 13.7 | 101 |
| | 4 | 895 | 756 | 8.6 | 105 |
| | 5 | 861 | 786 | 12.7 | 95 |
| | 6 | 960 | 885 | 11.4 | 105 |
| | 7 | 1165 | 1072 | 11 | 103 |
| | 8 | 1370 | 1280 | 2.2 | 104 |

Referring to FIGS. 3A and 3B and Table 6, it may be seen that the pure titanium specimens according to Comparative Examples 1 and 2 without ferrochrome added exhibit the tensile strength in a range of 418 to 758 MPa and the yield strength in a range of 352 to 672 MPa. On the other hand, it may be seen that the titanium alloy specimens prepared by adding ferrochrome in an amount equal to or smaller than 3.0% by weight to pure titanium have the tensile strength in a range of 540 to 1370 MPa and the yield strength in a range of 460 to 1280 MPa. In other words, it may be seen that, in the case of titanium alloy prepared by adding ferrochrome, the strength increases compared to that of pure titanium. In particular, referring to Table 6, it may be seen that Present Examples 3 to 7 have the tensile strength in a range of 861 to 1165 MPa and the good elongation.

Table 7 shows elongation measurement results and crack occurrence observation results of the specimens according to Comparative Examples 1 to 4 and specimens according to Present Examples 1 to 8.

TABLE 7

| | | Ferrochrome | O | Elongation | Crack |
|---|---|---|---|---|---|
| | No. | (wt. %) | (wt. %) | (%) | occurrence |
| Comparative | 1 | 0 | 0.05 | 21.8 | — |
| Example | 2 | 0 | 0.39 | 23.1 | — |
| | 3 | 4 | 0.05 | 1.4 | X |
| | 4 | 4 | 0.39 | 1.1 | ◯ |
| Present | 1 | 0.5 | 0.05 | 13.9 | X |
| Example | 2 | 1 | 0.05 | 16.8 | X |
| | 3 | 2 | 0.05 | 13.7 | X |
| | 4 | 3 | 0.05 | 8.6 | X |
| | 5 | 0.5 | 0.39 | 12.7 | X |
| | 6 | 1 | 0.39 | 11.4 | X |
| | 7 | 2 | 0.39 | 11 | X |
| | 8 | 3 | 0.39 | 2.2 | X |

Referring to FIGS. 3A and 3B and Table 7, when comparing Comparative Example 1, Present Examples 1 to 4, and Comparative Example 3 with each other, and when comparing Comparative Example 2, Present Examples 5 to 8, and Comparative Example 4 with each other, as ferrochrome is added to the pure titanium specimens, the elongation tends to decrease.

However, in the case of Comparative Examples 3 to 4, which is a case of adding 4.0% by weight of ferrochrome to pure titanium with an oxygen concentration in a range of 0.05 to 0.39% by weight, the elongation decreases sharply to be in a range of 1.1 to 1.4. On the other hand, it may be seen that, in the case of Present Examples 1 to 8, which is a case of adding ferrochrome in an amount smaller than 4.0% by weight, more specifically, smaller than 3.0% by weight to pure titanium with an oxygen concentration in the range of 0.05 to 0.39% by weight, the elongation is in a range of 2.2 to 16.8% without the sharp decrease. That is, when comparing Present Examples 1 to 4 and Comparative Example 3 with each other, and when comparing Present Examples 5 to 8 and Comparative Example 4 with each other, it may be seen that the addition of ferrochrome in the amount smaller than 4% by weight does not result in the sharp decrease in the elongation, but addition of ferrochrome in an amount equal to or greater than 4% by weight leads to the rapid decrease in the elongation.

Furthermore, when comparing Present Examples 1 to 3 with Present Example 4 and comparing Present Examples 5 to 7 with Present Example 8, it may be seen that a degree of the decrease in the elongation is greater when the amount of ferrochrome added is 3.0% by weight compared to when the amount of ferrochrome added is in a range of 0.5 to 2.0% by weight. Therefore, considering the strength and the elongation, it may be considered that the most desirable amount of ferrochrome added is in the range of 0.5 to 2.0% by weight.

Additionally, referring to Table 7, it may be seen that the cracks occurred in the titanium alloy specimen according to Comparative Example 4, but no cracks occurred in the titanium alloy specimens according to Present Examples 1 to 8.

As described above, the present disclosure has been described with reference to illustrative drawings, but the present disclosure is not limited by the embodiment disclosed herein and the drawings, and it is obvious that various modifications may be made by those skilled in the art within the scope of the technical idea of the present disclosure. In addition, although the effects of the composition of the present disclosure are not explicitly described and illustrated in the above description of the embodiment of the present disclosure, it is natural that the predictable effects of the corresponding composition should also be recognized.

What is claimed is:

1. A method for preparing a high-strength titanium alloy, the method comprising:
(a) adding ferrochrome to pure titanium (Ti);
(b) melting a result of the (a) and then cooling the result to form a titanium alloy base material; and
(c) hot forming the titanium alloy base material,
wherein the ferrochrome includes iron (Fe): 20 to 35% by weight, silicon (Si): 1 to 4% by weight, and carbon (C): equal to or smaller than 0.15% by weight, with a remainder composed of chromium (Cr) and inevitable impurities,
wherein the ferrochrome is added in an amount equal to or smaller than 4% by weight with respect to a total weight of the titanium alloy.

2. The method of claim 1, wherein the ferrochrome is added in an amount in a range of 0.5 to 2% by weight with respect to the total weight of the titanium alloy.

3. The method of claim 1, wherein the hot forming is performed in a temperature range of 800 to 850° C. with a forming ratio equal to or lower than 90%.

4. The method of claim 1, wherein the prepared titanium alloy includes chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, with a remainder composed of titanium (Ti) and inevitable impurities, wherein the prepared titanium alloy has a tensile strength in a range of 861 to 1165 MPa.

5. A high-strength titanium alloy comprising:
chromium (Cr): 0.1 to 3.0% by weight, iron (Fe): 0.1 to 1.0% by weight, silicon (Si): 0.01 to 0.1% by weight, and oxygen (O): equal to or smaller than 0.4% by weight, wherein the content of chromium (Cr) is greater than the content of iron (Fe), wherein the high-strength titanium alloy also includes a remainder composed of titanium (Ti) and inevitable impurities,
wherein the high-strength titanium alloy has a tensile strength in a range of 861 to 1165 MPa.

6. The high-strength titanium alloy of claim 5, wherein the content of chromium is 1.7 to 4 times the content of iron.

7. The high-strength titanium alloy of claim 5, wherein the titanium alloy has a molybdenum equivalent weight ([Mo]eq.), expressed in Equation 1 below, equal to or smaller than 5 and has a beta transformation point in a range of 840 to 930° C.
$$[ Mo ] eq . = [ Mo ] + 0.2 [ Ta ] + 0.28 [ Nb ] + 0.4 [ W ] + 0.67 [ V ] + 1 \text{.25} [ Cr ] + 1.25 [ Ni ] + 1.7 [ Mn ] + 1.7 [ Co ] + 2.5 [ Fe ] \qquad [ Equation l ]$$

8. The high-strength titanium alloy of claim 5, wherein the titanium alloy has a yield strength in a range of 460 to 1280 MPa and a Young's modulus in a range of 95 to 105 GPa.
